(19) United States
(12) Patent Application Publication
(10) Pub. No.: US 2006/0257156 A1
(43) Pub. Date: Nov. 16, 2006

(54) Image forming apparatus for determining conveying state of printing medium and a method thereof

(75) Inventors: Myung-ho Kyung, Suwon-si (KR); Yong-baek Yoo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/341,428

(22) Filed: Jan. 30, 2006

(30) Foreign Application Priority Data
May 12, 2005 (KR) 2005-0039759

(51) Int. Cl. G03G 15/00

(52) U.S. Cl. 399/16

(57) ABSTRACT

An image forming apparatus for determining a state of conveying a printing medium and a method thereof are disclosed. The image forming apparatus includes a convey belt rotating in a caterpillar manner for conveying a printing medium to a photoconductor. A charge roller charges a printing medium that enters the convey belt. A convey roller faces the charge roller and forms a convey nib with the charge roller. A transfer unit transfers a developer image formed on the photoconductor to the printing medium. A resistance detector constantly detects resistance of the convey roller. A controller determines whether the resistance is varied within a reference time.

### CROSS-REFERENCE TO RELATED APPLICATIONS

This application claims the benefit under 35 U.S.C. § 119(a) of Korean Patent Application No. 2005-39759, filed May 12, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to determining a state of conveying a printing medium and a method thereof in an image forming apparatus.

2. Description of the Related Art

A color image forming apparatus, such as, a copier, a printer, or a multifunctional device, forms images through an electro-photographic processing. For example, a latent image is formed on a plurality of photoconductors. The latent image is developed using color developers to form developer images of each color. The developer images are transferred and overlapped on a printing medium directly or through an intermediate transfer unit to a color image.

FIG. 1 shows a color image forming apparatus according to the related art. The color image forming apparatus in FIG. 1 forms images directly on the printing medium without using an intermediate transfer unit.

Referring to FIG. 1, the color image forming apparatus includes image forming units 10 to form images of four colors, that is, black, yellow, magenta, and cyan. Each of the image forming units 10 includes: a photoconductor 11, a charge roller (not shown), a developer roller 12 and a developer case 13. A predetermined electrostatic latent image is formed on each photoconductor 11 by a laser beam irradiated from a light scanning unit 20, and the electrostatic latent image is developed as a developer image by a developer supplied from a developer roller 12.

A conveying unit 30 for conveying a printing medium includes: a convey belt 31 rotating in a caterpillar manner in contact with the plurality of photoconductors 11, and belt supporting rollers 33 and 35 for rotatably supporting the convey belt 31.

Transfer rollers 41 are disposed inside the convey belt 31 to face the photoconductors 11. As described above, the printing medium conveys between the plurality of photoconductors 11 and the convey belt 31, and the developer images of the photoconductors 11 are transferred and overlapped on the printing medium P traveling along the convey belt 31.

A printing medium P is picked up by a pickup roller 52 from a paper supply cassette 51 disposed in a main body 50. The picked-up printing medium P is conveyed between the photoconductor 11 and the convey belt 31. A charge roller 55 is disposed to face the belt supporting rollers 33 and 35. The charge roller 55 generates electrostatic energy to closely adhere the printing medium P to the convey belt 31, while the printing medium P is conveyed by the convey belt 31. Such an electrostatic energy helps to convey the printing medium P to a target location.

A fuser unit 60 fixes a color image on a printing medium P applying heat and pressure to the transferred image on the printing medium P by the transfer roller 41.

The printing medium P, with fixed images, is outputted through an eject roller 80 to a paper output tray 90.

The image forming apparatus, according to the related art, additionally includes a senor to determine a state of conveying the printing medium picked up by the pickup roller 52 and inserted between the discharge roller 55 and the belt supporting roller 33.

### SUMMARY OF THE INVENTION

An aspect of embodiments of the present invention is to address at least the above problems and/or disadvantages and to provide at least the advantages described below. Accordingly, an aspect of embodiments of the present invention is to provide an image forming apparatus determining a state of conveying a printing medium through analyzing resistance variation of a convey roller facing a discharge roller.

It is another aspect of an exemplary embodiment of the present invention to provide a method of determining a state of conveying a printing medium used in an image forming apparatus.

In accordance with an aspect of an exemplary embodiment of the present invention, there is provided an image forming apparatus that includes a convey belt rotating in a caterpillar manner for conveying a printing medium to a photoconductor. A charge roller charges a printing medium that enters the convey belt. A convey roller faces the charge roller and forms a convey nib with the charge roller. A transfer unit transfers a developer image formed on the photoconductor to the printing medium. A resistance detector constantly detects resistance of the convey roller. A controller determines whether the resistance is varied within a reference time.

The controller may start to perform a counting operation when the printing medium is sensed before the printing medium enters the convey nib, and determines whether the detected resistance is varied within the reference time in order to determine a state of conveying the printing medium.

The controller may start to count a time, if the resistance is varied when a front end of the printing medium enters the convey nib, and determines whether the resistance of the convey roller is varied again within a reference time in order to determine a state of conveying the printing medium.

The image forming apparatus may further include a power supply for supplying voltage to the charger roller.

The controller may control a time of applying high voltage to the transfer unit based on the time of varying the resistance when the front end of the printing medium enters the convey nib.

The convey roller may rotatably support one end of the convey belt.

In accordance with another aspect of an exemplary embodiment of the present invention, there is provided an image forming apparatus that includes a first convey roller receiving voltage. A second convey roller is disposed to face the first convey roller and forms a convey nib with the first convey roller. A resistance detector constantly detects resistance of the second convey roller. A controller determines a time of varying the resistance and determines whether the detected resistance is varied within a reference time after a predetermined time.

The controller may start to perform a counting operation when the printing medium is located at a predetermined position before the printing medium enters the convey nib, and determine that the printing medium is abnormally conveyed if the resistance is not varied within the reference time after performing the counting operation.

The controller may perform a counting operation, if the resistance is varied when the printing medium enters the convey nib, and determines that the printing medium is jammed at the convey nib, if the resistance is not varied again within a reference time.

In accordance with a further aspect of an exemplary embodiment of the present invention, there is provided a method of determining a state of conveying a printing medium in an image forming apparatus. A printing medium is sensed before the printing medium enters a convey nib formed of a charge roller and a convey roller. Resistance is detected of the convey roller. The detected resistances of the convey roller are compared and determined as being varied by counting a time after sensing the printing medium before the printing medium enters the convey nib. The printing medium is determined as being abnormally conveyed before the printing medium enters the convey nib, if the detected resistances are not varied.

In the sensing of the print medium, a time of picking up the printing medium from a paper supply cassette may be sensed.

A time of supplying a high voltage to a transfer unit may be determined based on a time of varying the resistance, which is varied by the printing medium entering the convey nib.

A convey belt rotating in a caterpillar manner is disposed between the charge roller and the convey roller, and the convey roller may rotatably support one side of the convey belt.

In accordance with still another aspect of an exemplary embodiment of the present invention, there is provided a method of determining a state of conveying a printing medium in an image forming apparatus. Resistance of a convey roller facing a charge roller is detected. A time starts to count, if the detected resistance is varied when the printing medium enters a convey nib formed of the charge roller and the convey roller, and the resistance is determined as being varied again within a reference time. The printing medium is determined as being abnormally conveyed at the convey nib, if the resistance of the convey roller is not varied again during the determining of the resistance variation.

A time of supplying a high voltage to a transfer unit may be determined based on the time of varying the resistance by the printing medium entering the convey nib.

A convey belt rotating in a caterpillar manner may be disposed between the charge roller and the convey roller, and the convey roller rotatably supports one side of the convey belt.

In accordance with still another aspect of an exemplary embodiment of the present invention, there is provided a method of determining a state of conveying a printing medium in an image forming apparatus. A printing medium is sensed before entering a convey nib formed by a first convey roller and a second convey roller. Resistance of at least one of the first convey roller and the second convey roller is detected. The resistance of at least one of the first convey roller and the second convey roller is determined as being varied, by starting to count a time when the printing medium is sensed before entering the convey nib. The printing medium is determined as being abnormally conveyed before the printing medium enters the convey nib, if the resistance of the convey roller is not varied during the determining of the resistance variation.

In accordance with a further aspect of an exemplary embodiment the present invention, there is provided a method of determining a state of conveying a printing medium in an image forming apparatus. Resistance of a second convey roller facing a first convey roller is detected. The resistance of the second convey roller is determined as being varied within a reference time by starting to count a time if the resistance is varied when the printing medium enters a convey nib formed by the first convey roller and the second convey roller. The printing medium is determined as being abnormally conveyed at the convey nib, if the resistance of the second convey roller is not varied again during the determining of the resistance.

### BRIEF DESCRIPTION OF THE DRAWINGS

The above aspects and other objects, features, and advantages of certain exemplary embodiments of the present invention will be more apparent from the following description taken in conjunction with the accompanying drawings, in which:

FIG. 1 shows a conventional image forming apparatus directly transferring and overlapping developer images on a printing medium;

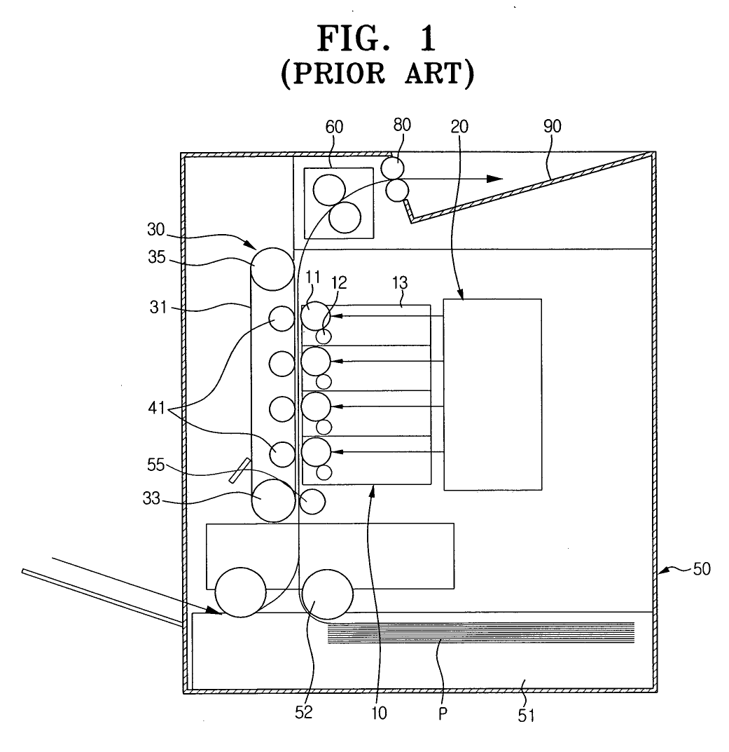

FIG. 2 is a diagram illustrating an image forming apparatus for determining a state of conveying a printing medium according to an exemplary embodiment of the present invention;

FIG. 3 is a flowchart for explaining a method of determining a state of conveying a printing medium after picking up the printing medium and before the picked up printing medium enters a convey nib according to an exemplary embodiment of the present invention;

FIG. 4 is a graph for explaining a method of determining a state of conveying a printing medium according to an exemplary embodiment of the present invention; and

FIG. 5 is a flowchart for explaining a method of determining a state of conveying a printing medium after the printing medium enters a convey nib according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

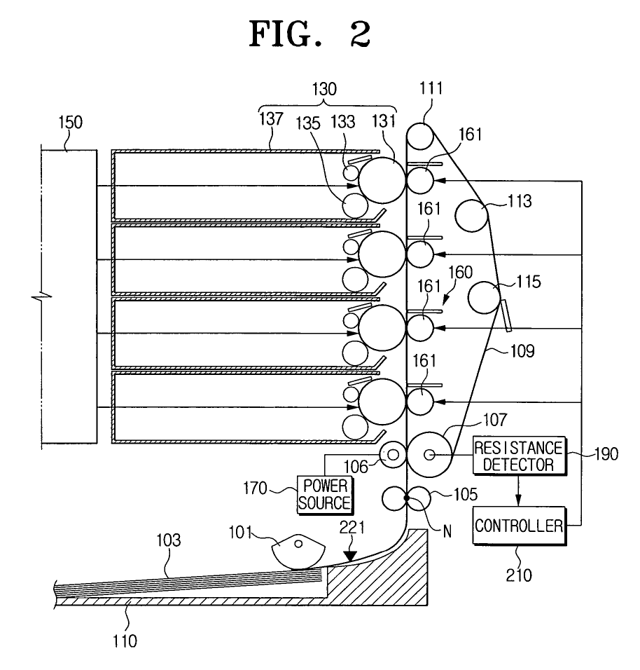

FIG. 2 is a diagram illustrating an image forming apparatus for determining a state of conveying a printing medium according to an exemplary embodiment of the present invention. Referring to FIG. 2, an operation of determining a state of conveying a printing medium based on resistance variation of a convey roller contacting a charge roller will be described.

Referring to FIG. 2, a pickup roller 101 picks up a printing medium 103 from a paper supply cassette 110. The picked-up printing medium 103 enters through a convey roller 105 and between the charge roller 106 and a convey roller 107. A convey belt 109 rotating in a caterpillar manner is disposed between the charge roller 106 and the convey roller 105. The picked-up printing medium 103 closely adheres to the convey belt 109 and the convey belt 109 conveys the printing medium 103 in an upward direction. The convey roller 107 rotatably supports one side of the convey belt 109 to rotate in a caterpillar manner, and a belt support roller 111 is disposed at an opposite side facing the convey roller 107. A plurality of convey rollers 113 and 115 may be disposed to support the convey belt 109 to rotate in a caterpillar manner.

Four image forming units for four colors, that is, black, yellow, magenta, and cyan, are disposed in parallel to make contact with the covey belt 109. Each of the image forming units 130 includes a photoconductor 131, a charge roller 133, a developer roller 135, and a developer case 137. A predetermined electrostatic latent image is formed on the photoconductor 131 by a laser beam irradiated from a light scanning unit 150. The electrostatic latent image is developed by a developer supplied from the developer roller 135. A plurality of transfer rollers 161 is disposed inside the convey belt 109 corresponding to each of the photoconductors 131 as a transfer unit 160.

The charge roller 106 is connected to a power source 170, and electric power is applied to the charge roller 106. Accordingly, the charge roller 106 creates electrostatic energy to closely adhere the printing medium 103 on the convey belt 109 to safely convey the printing medium 103 to a target place.

A resistance detector 190 is connected to the convey roller 109 facing the charge roller 106 to detect variation of resistance when the printing medium 103 is passed through a convey nib N that denotes a location between the charge roller 106 and the convey roller 107.

The resistance detector 190 is connected to a controller 210. The controller 210 consistently analyzes resistance values transferred from the resistance detector 190 and determines whether the printing medium 103 enters the convey nib N based on a variation of detected resistance value. That is, the controller 210 counts the variation of the detected resistance values, and analyzes variations in a unit of time. Based on an analysis result, the controller 210 determines whether the printing medium 103 enters the convey nib N. An analysis operation of the controller 210 will be described in detail later.

The image forming apparatus according to an exemplary embodiment of the present invention further includes a sensor 221 to sense the printing medium 103 picked up from the paper supply cassette 110 and conveyed to the convey nib N as shown in FIG. 2.

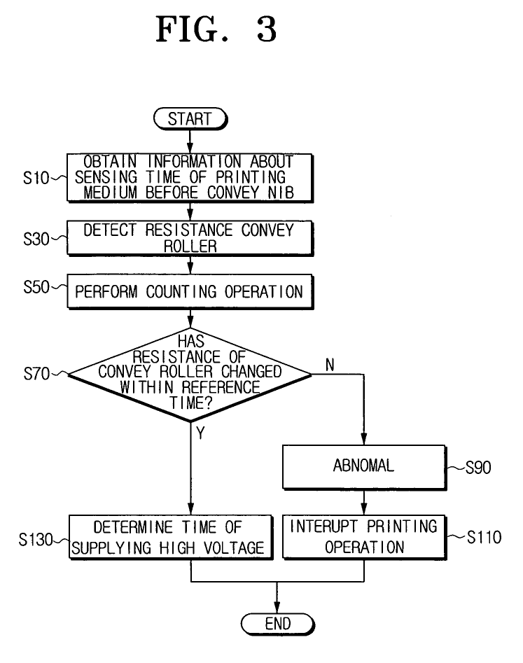

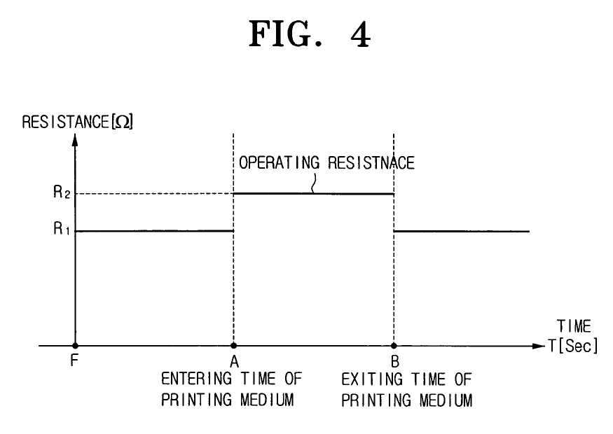

Hereinafter, a method of determining a state of conveying a printing medium based on a resistance of a convey roller will be described in detail with reference to FIGS. 3 and 4.

FIG. 3 is a flowchart describing a method of determining a state of conveying a printing medium before the printing medium enters the convey nib N for the image forming apparatus shown in FIG. 2. FIG. 4 is a graph for explaining the method of determining a state of conveying a printing medium according to an exemplary embodiment of the present invention.

Referring to FIG. 3, when the printing medium 103 is picked up by the pickup roller 101, the picked up printing medium 103 is detected by the sensor 221 in operation S10.

Meanwhile, the resistance detector 190 constantly detects resistance of the convey roller 107 in operation S30.

The controller 210 starts to count a time when the printing medium 103 is picked up from the paper supply cassette in operation S50.

The printing medium 103 is continuously conveyed while constantly detecting the resistance and counting the time by the controller 210. When the printing medium 103 enters the convey nib N, the resistance is varied. The controller 210 detects the variation of the resistance to determine a time that the printing medium 103 enters the convey nib N in operation S70. Herein, if the resistance has not been varied until the counted time reaches a predetermined reference value, the controller 210 determines that the conveying state of the printing medium 103 is abnormal in operation S90, and the controller 210 interrupts the printing operation of the image forming apparatus in operation S110.

Thereafter, in operation S130, the controller 210 controls a time of applying a high voltage of a transfer roller 161 based on the detected time of entering the printing medium 103, which is detected in operation S70.

Hereinafter, operation S70 will be described in more detail with reference to FIG. 4.

Referring to FIG. 4, a time F on a parallel axis in the graph denotes a time of sensing a printing medium 103 when the printing medium 103 is picked up from the paper supply cassette. A time A on a parallel axis denotes a time of sudden increases of resistance. That is, the point A represents a time that the printing medium enters into the convey nib N. Accordingly, the controller 210 compares a reference resistance R1 and an operation resistance R2, where R1 denotes a resistance before the printing medium 103 enters the convey nib N and R2 denotes the increased resistance after the printing medium 103 enters the convey nib N. If the difference between R1 and R2 exceeds a predetermined range, the controller 210 determines that the printing medium 103 enters the convey nib N.

A period F-A in FIG. 4 represents a reference time of conveying the printing medium from the time F, denoting the picking up of the printing medium 103, to the time A representing the entering of the convey nib N. That is, the period F-A represents a time after the pickup roller 101 picks up the printing medium 103 until the printing medium 103 enters the convey nib N. Accordingly, the controller 210 determines that a printing medium 103 is jammed before the printing medium 103 enters the convey nib N, if the resistance has been not varied until the time counted in the operation S30 reaches to the reference time, which is defined by the period F-A.

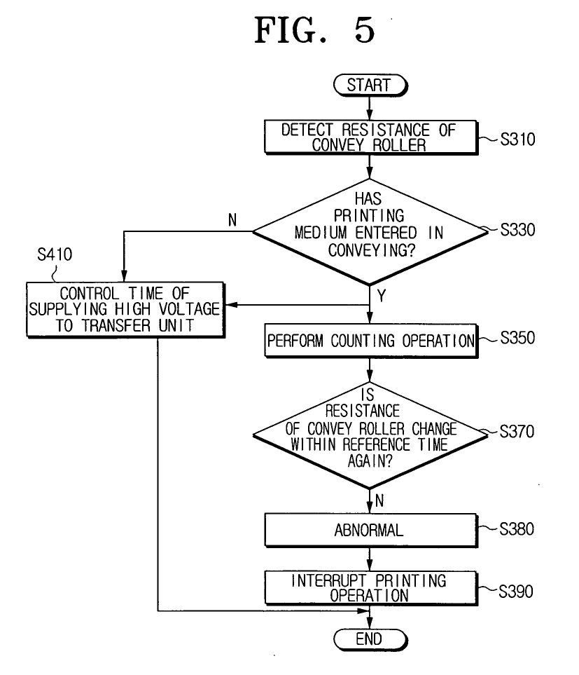

FIG. 5 is a flowchart showing a method of determining a state of conveying a printing medium after the printing medium enters the convey nib N, according to an exemplary embodiment of the present invention.

Referring to FIG. 5, resistance of the convey roller 107 is constantly detected in operation S310.

In operation S330, a point of time of varying the detected resistance is detected in operation S330. That is, the controller 210 detects the time A of FIG. 4 which denotes that the printing medium 103 enters the convey nib N. Herein, a method of detecting the time A is identical to the detection method described with reference to FIG. 4. Therefore, a detailed description will be omitted for clarity and conciseness.

The controller 210 counts a time after the printing medium enters the convey nib N in operation S350.

The controller 210 continuously determines whether the resistance of the convey roller 107 is varied within a reference time after the printing medium enters the convey nib N in operation S370.

If the resistance has not been varied for the reference time, the controller 210 determines that the printing medium is jammed in operation S380.

The controller 210 controls a time of applying high voltage of the transfer roller 161 which is a transfer unit 160 based on the entering time of the convey nib N in operation S410.

Hereinafter, the operation S370 will be described in more detail with reference to FIG. 4.

Referring to FIG. 4, the graph shows a period A-B of the operating resistance R2, which is a higher resistance level than the reference resistance R1.

As described above, the time A denotes the time that the printing medium 103 enters the convey nib N. A time B on the parallel axis denotes a time that a bottom end of the printing medium exits from the convey nib N. If the resistance of the convey roller has not been changed until a time is elapsed as long as the time period A-B after the time A, the controller 210 determines that the printing medium 103 is jammed at the convey nib N according to the operation S350.

As described above, the conveying state of the printing medium 103 is determined by detecting the resistance of the convey roller 107 facing the charge roller 106 in the present invention. However, the image forming apparatus and the method thereof, according to the present invention, can be applied to any type of convey rollers conveying the printing medium.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus comprising:
a convey belt rotating in a caterpillar manner for conveying a printing medium to a photoconductor;
a charge roller for charging the printing medium;
a convey roller facing the charge roller and forming a convey nib with the charge roller;
a transfer unit for transferring a developer image formed on the photoconductor to the printing medium;
a resistance detector for detecting a resistance of the convey roller; and
a controller for determining whether the resistance is varied.

2. The image forming apparatus of claim 1, wherein the resistance detector is configured to constantly detect the resistance.

3. The image forming apparatus of claim 1, wherein the controller is configured to determine whether the resistance varies within a reference time period.

4. The image forming apparatus of claim 1, wherein the controller starts to perform a counting operation when the printing medium is sensed before the printing medium enters the convey nib, and determines whether the detected resistance is varied within the reference time period in order to determine a state of conveying the printing medium.

5. The image forming apparatus of claim 1, wherein the controller starts to count a time if the resistance is varied when a front end of the printing medium enters the convey nib, and determines whether the resistance of the convey roller is varied again within a reference time period in order to determine a state of conveying the printing medium.

6. The image forming apparatus of claim 1, further comprising a power supply for supplying voltage to the charger roller.

7. The image forming apparatus of claim 1, wherein the controller controls a time of applying high voltage to the transfer unit based on a time of varying the resistance when the front end of the printing medium enters the convey nib.

8. The image forming apparatus of claim 1, wherein the convey roller rotatably supports one end of the convey belt.

9. An image forming apparatus comprising:
a first convey roller for receiving a voltage;
a second convey roller disposed to face the first convey roller and for forming a convey nib with the first convey roller;
a resistance detector for detecting resistance of the second convey roller; and
a controller for determining whether the detected resistance is varied.

10. The image forming apparatus of claim 9, wherein the resistance detector is configured to constantly detect the resistance.

11. The image forming apparatus of claim 9, wherein the controller is configured to determine a time of varying the resistance.

12. The image forming apparatus of claim 9, wherein the controller is configured to determine whether the detected resistance varies within a reference time after a time period.

13. The image forming apparatus of claim 9, wherein the controller starts to perform a counting operation when the printing medium is located at a first position before the printing medium enters the convey nib, and determines that the printing medium is abnormally conveyed if the resistance is not varied within a reference time period after performing the counting operation.

14. The image forming apparatus of claim 9, wherein the controller performs a counting operation if the resistance is varied when the printing medium enters the convey nib, and the controller determines that the printing medium is jammed at the convey nib if the resistance is not varied within a reference time period.

15. A method of determining a state of conveying a printing medium in an image forming apparatus, the method comprising:
sensing a printing medium before the printing medium enters a convey nib formed by a charge roller and a convey roller;
detecting resistance of the convey roller;
evaluating the detected resistance of the convey roller and determining whether the detected resistance is varied; and
determining that the printing medium is abnormally conveyed before the printing medium enters the convey nib, if the detected resistances are not varied.

16. The method of claim 15, wherein the sensing of the print medium comprises sensing a time of picking up the printing medium from a paper supply cassette.

17. The method of claim 15, wherein evaluating the detected resistance comprises counting a time after sensing the printing medium, before the printing medium enters the convey nib.

18. The method of claim 15, further comprising determining a time of supplying a high voltage to a transfer unit based on a time of varying the resistance, which is varied by the printing medium entering the convey nib.

19. The method of claim 15, wherein a convey belt rotating in a caterpillar manner is disposed between the charge roller and the convey roller, and the convey roller rotatably supports one side of the convey belt.

20. A method of determining a state of conveying a printing medium in an image forming apparatus, the method comprising:
detecting resistance of a convey roller facing a charge roller;
starting to count a time, if the detected resistance is varied when the printing medium enters a convey nib formed by of the charge roller and the convey roller, and determining whether the resistance is varied within a reference time period; and
determining that the printing medium is abnormally conveyed at the convey nib, if the resistance of the convey roller is not varied during the determining of the resistance variation.

21. The method of claim 20, further comprising determining a time of supplying a high voltage to a transfer unit based on the time of varying the resistance by the printing medium entering the convey nib.

22. The method of claim 20, wherein a convey belt rotating in a caterpillar manner is disposed between the charge roller and the convey roller, and the convey roller rotatably supports one side of the convey belt.

23. A method of determining a state of conveying a printing medium in an image forming apparatus, the method comprising:
sensing a printing medium before entering a convey nib formed by of a first convey roller and a second convey roller;
detecting resistance of at least one of the first convey roller and the second convey roller;
determining whether the resistance of at least one of the first convey roller and the second convey roller is varied; and
determining that the printing medium is abnormally conveyed before the printing medium enters the convey nib, if the resistance of the convey roller is not varied in the determining of the resistance variation.

24. The method of claim 23, wherein detecting the resistance comprises detecting the resistance constantly.

25. The method of claim 23, wherein determining whether the resistance is varied comprises starting to count a time when the printing medium is sensed before entering the convey nib.

26. A method of determining a state of conveying a printing medium in an image forming apparatus, the method comprising:
detecting resistance of a second convey roller facing a first convey roller;
determining whether the resistance of the second convey roller is varied within a reference; and
determining that the printing medium is abnormally conveyed at the convey nib, if the resistance of the second convey roller is not varied during the determining of the resistance.

27. The method of claim 26, wherein determining whether the resistance is varied comprises starting to count a time, if the resistance is varied when the printing medium enters a convey nib formed by the first convey roller and the second convey roller.
